(19) United States
(12) Patent Application Publication
(10) Pub. No.: US 2024/0312671 A1
(43) Pub. Date: Sep. 19, 2024

(54) REDUCING HIGH FREQUENCY FUNDAMENTAL COUPLING IN POLYPHASE CABLES

(71) Applicant: BAE Systems Controls Inc., Endicott, NY (US)

(72) Inventors: Matthew S. Boecke, Endicott, NY (US); Joshua P. Stewart, Vestal, NY (US); Arthur P. Lyons, Maine, NY (US); Robert J. Vovos, Vestal, NY (US); Jeffrey E. Coughlin, Endicott, NY (US); Brad J. Mulcahy, Castle Creek, NY (US)

(73) Assignee: BAE Systems Controls Inc., Endicott, NY (US)

(21) Appl. No.: 18/121,225

(22) Filed: Mar. 14, 2023

(51) Int. Cl. H01B 7/30; H01B 9/02

(52) U.S. Cl. CPC H01B 7/30; H01B 9/028

(57) ABSTRACT

A polyphase cable includes a first conductor, a first shield including conductive material coaxially around the first conductor, and a first insulating material between and separating the first conductor and the first shield. The polyphase cable further includes a second conductor, a second shield including conductive material coaxially around the second conductor, and a second insulating material between and separating the second conductor and the second shield. In an example, the first shield is in physical contact, and in electrical contact, with the second shield. In an example, the polyphase cable is configured to conduct polyphase Alternating Current (AC) having a frequency of at least 100 Hertz (Hz) and/or at most 10,000 Hz. In an example, one or both of a first end and a second end of one or both of the first shield and the second shield are configured to be grounded.

### TECHNICAL FIELD

The present disclosure relates generally to cables, and more particularly to polyphase alternating current (AC) cables.

### BACKGROUND

A multi-conductor cable, such as a polyphase cable, includes more than one conductor assemblies within the cable. For example, a cable suitable for 3-phase application has three conductor assemblies. Each conductor assembly may have a conductive conductor, a conductive phase shield arranged around the conductive, and a layer of insulating or dielectric material between the conductor and the phase shield. The conductor, insulating material, and phase shield are coaxially arranged, e.g., such that they share a common geometric axis. Each conductor of a corresponding conductor assembly conducts current of a corresponding phase of the polyphase (such as 3-phase) alternating current (AC). Polyphase cables may be used for a variety of applications, such as for electrical power delivery, driving an electrical drive or a motor, and/or any appropriate application in which polyphase power may be used. There remain several non-trivial issues with respect to designing and operating polyphase cables.

### BRIEF DESCRIPTION OF THE DRAWINGS

FIGS. 1, 2, 3, and 4 illustrate various views of an example polyphase high frequency (such as a frequency of at least 100 Hz, for example) Alternating Current (AC) cable comprising a plurality of conductor assemblies corresponding to a plurality of AC phases, wherein each conductor assembly comprises (i) a corresponding conductor and (ii) a corresponding conductive phase shield arranged coaxially around the conductor, and wherein the plurality of conductive phase shields of the plurality of conductor assemblies are grounded and electrically coupled to and in physical contact with each other, in accordance with an embodiment of the present disclosure.

FIG. 5 illustrates another example polyphase high frequency AC cable that is at least in part similar to the polyphase high frequency AC cable of FIGS. 1-4, and wherein the plurality of conductive phase shields of the plurality of conductor assemblies of the cable of FIG. 5 are grounded and electrically coupled to (but not necessarily physically coupled to) each other, in accordance with an embodiment of the present disclosure.

FIG. 6 illustrates cross-sectional view of an example four-phase high frequency AC cable comprising four conductor assemblies corresponding to the four phases, wherein each conductor assembly comprises (i) a corresponding conductor and (ii) a corresponding conductive phase shield arranged coaxially around the conductor, and wherein the four conductive phase shields of the four conductor assemblies are grounded and electrically coupled to and each other, in accordance with an embodiment of the present disclosure.

FIG. 7 illustrate a flowchart depicting a method for manufacturing a polyphase high frequency AC cable, such as any of the cables of FIGS. 1-6, wherein the cable comprises a plurality of conductor assemblies, wherein each conductor assembly comprises (i) a corresponding conductor and (ii) a corresponding conductive phase shield arranged coaxially around the conductor, and wherein the plurality of conductive phase shields of the plurality of conductor assemblies are grounded and electrically coupled to with each other, in accordance with an embodiment of the present disclosure.

The figures depict various embodiments of the present disclosure for purposes of illustration only and are not necessarily drawn to scale. Numerous variations, configurations, and other embodiments will be apparent from the following detailed discussion.

### DETAILED DESCRIPTION

Disclosed herein are polyphase AC cables having electrically coupled and grounded phase shields, wherein the electrical coupling between the phase shields helps to eliminate or otherwise reduce fundamental frequency coupling between a corresponding conductor and the corresponding phase shield, which in turn helps to reduce power loss within the phase shields. In one embodiment, such a cable may be suitable for relatively high frequency (such as a frequency of at least 100 Hz, for example) operation, as the fundamental frequency coupling is more pronounced in such high frequency range of operation, although the cable may also be used for lower frequencies of operation as well.

In some embodiments, the polyphase cable comprises a plurality of conductor assemblies corresponding to the plurality of AC phases. Each conductor assembly comprises (i) a corresponding conductor and (ii) a corresponding conductive phase shield arranged coaxially around the conductor. In some such embodiments, in each conductor assembly, one or more layers of semi-conductive material and one or more layers of insulating material are arranged coaxially between the corresponding conductor and the corresponding phase shield.

Thus, the polyphase cable includes a plurality of phase shields, corresponding to the plurality of conductor assemblies. As described herein, each of such phase shields is in physical contact with one or more others of the phase shields, and is in electrical contact with each other. For example, a first phase shield is in physical contact with a second phase shield, which is in physical contact with a third phase shield, and so on, thereby resulting in the phase shields being in electrical contact with each other. In a three phase cable system, each phase shield is in physical and electrical contact with the two other phase shields of the cable, in an example. In one embodiment, each phase shield is grounded at one or both ends of the cable.

As described herein, grounding each phase shield and electrically coupling the phase shields result in elimination or at least reduction of the above described power loss due to a fundamental frequency coupling between a corresponding conductor and the corresponding phase shield. For example, electrically coupling the phase shields allows to at least in part cancel out or reduce the current flow through the phase shields, e.g., by cancelling out effects of coupling of the high fundamental frequency current. This results in zero or at least decreased power loss in the phase shields of the polyphase cable, thereby improving performance, thermal margin, and/or thickness and weight of the cable.

In one embodiment, the plurality of conductor assemblies may be surrounded by a plurality of additional layers, such as a cable jacket comprising insulating or dielectric fill material, a binding tape comprising insulating or dielectric fill material, an outer shield comprising conductive material (such as braided metal(s) and/or alloys thereof), and/or on outer insulation material layer, in some examples. Thus, in an example, a phase shield of a conductor assembly, along with the outer shield, provides two shielding layers to individual conductors. Such dual or double shielded arrangement results in better management of electromagnetic interface (EMI), such as reduction in EMI, without corresponding significant increase in power loss due to the above described coupling of fundamental frequency currents (e.g., as the phase shields are electrically coupled to each other, such power loss is eliminated or at least reduced). Numerous variations and embodiments will be apparent in light of the present disclosure.

### General Overview

As mentioned herein above, there remain several non-trivial issues with respect to designing and operating polyphase cables. For example, as described herein above, a polyphase cable includes multiple (such as three or more, corresponding to three or more AC phases) conductor assemblies within the cable, where each conductor assembly may have a conductive conductor, a conductive phase shield arranged around the conductor, and one or more layers of insulating or dielectric material between the conductor and the phase shield. In an example, a single turn transformer may develop for each conductor assembly, which may allow to couple the fundamental frequency of operation between each conductor and the corresponding phase shield. For example, for a three-phase cable, a single turn transformer may couple a fundamental frequency between a first conductor and a first phase shield around the first conductor, another single turn transformer may couple the fundamental frequency between a second conductor and a second phase shield around the second conductor, and yet another single turn transformer may couple the fundamental frequency between a third conductor and a third phase shield around the third conductor. Such couplings of the fundamental frequency result in current conduction though the phase shields. This results in power loss in the cable. Such power loss may be especially prominent for relatively high frequency operation of the cable, such as for a frequency greater than 100 Hz, for example. In an example, such power loss may contribute to relatively smaller thermal margins and/or relatively heavier cables.

Accordingly, techniques are described herein to form a polyphase AC cable having electrically coupled phase shields, wherein the electrically coupling between the phase shields results in elimination or at least reduction of the above described power loss due to fundamental frequency coupling between a corresponding conductor and the corresponding phase shield. In one embodiment, the cable is suitable for relatively high frequency (such as a frequency of at least 100 Hz, for example) operation, as the above discussed power loss is more pronounced in such high frequency range of operation, although the cable may also be used for lower frequencies of operation as well.

In some embodiments, the polyphase cable comprises a plurality of conductor assemblies corresponding to the plurality of AC phases. For example, a three-phase cable would include corresponding three conductor assemblies. Each conductor assembly comprises (i) a corresponding conductor and (ii) a corresponding conductive phase shield arranged coaxially around the conductor. The phase shields comprise conductive material, such as one or more metals and/or alloys thereof. Any appropriate metal may be used, such as copper, aluminum, and/or nickel. In an example, each phase shield comprises metallic braid or tape wrap.

In some embodiments, in a conductor assembly, one or more layers of semi-conductive material and one or more layers of insulating material are arranged coaxially between the corresponding conductor and the corresponding phase shield. In some such embodiments, the one or more layers of semi-conductive material grade the charge of the conductor, so as to eliminate or reduce partial discharge or corona effect in the conductor assembly and cause a slower rate of dissipation of the voltage of the conductor. For example, in a conductor assembly, a first layer of semi-conductive material may be coaxially around the conductor, a layer of insulating material may be coaxially around the first layer of semi-conductive material, a second layer of semi-conductive material may be coaxially around the layer of insulating material, and the phase shield may be coaxially around the layer of second layer of semi-conductive material. In an example, a number, thickness and/or material of such layers of semi-conductive material may be implementation specific, and may depend on a voltage rating of the cable.

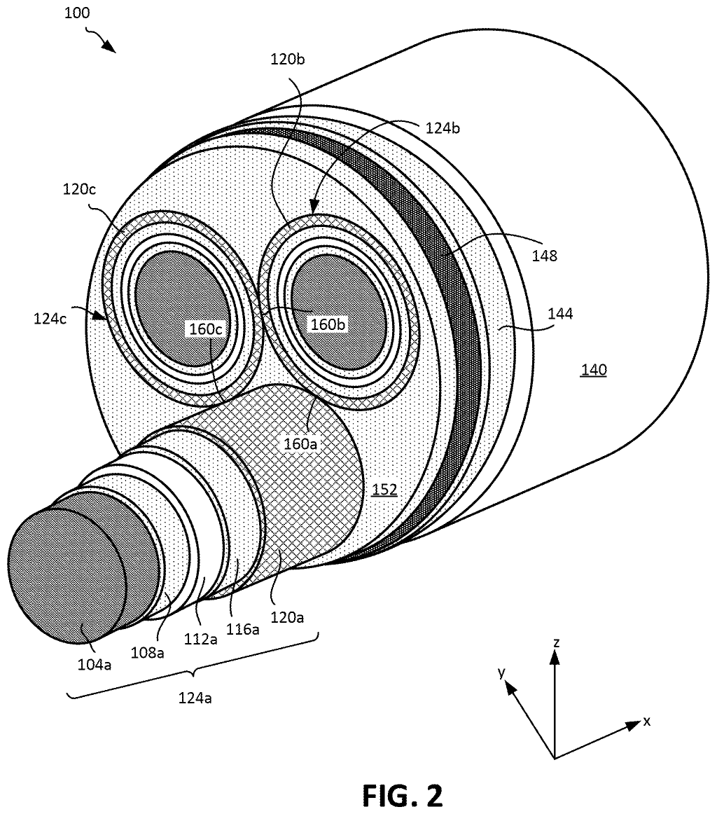

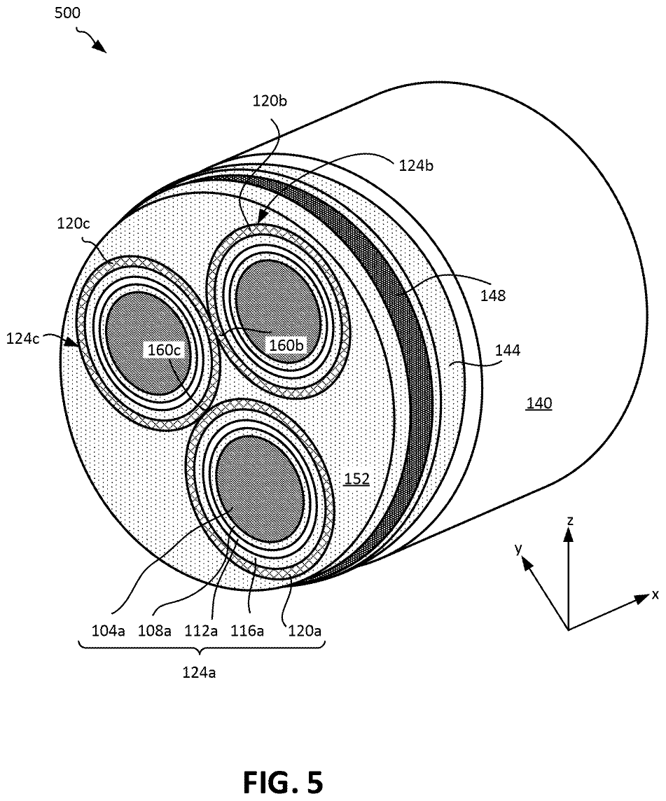

As described above, the polyphase cable includes a plurality of phase shields, corresponding to the plurality of conductor assemblies. As described herein, each of such phase shields is in physical contact with one or more others of the phase shields, and is in electrical contact with each other. For example, a first phase shield is in physical contact with a second phase shield, which is in physical contact with a third phase shield, and so on, thereby resulting in the phase shields being in electrical contact with each other. For a three phase cable, for example, each phase shield may be in electrical and physical contact with each other, e.g., see FIGS. 2-4 described below (although in another example, they may not be in direct physical contact with each other, e.g., see FIG. 5). In one embodiment, each phase shield is grounded at one or both ends of the cable.

Two phase shields may be electrically coupled to each other by either direct physical contact or indirect physical contact.

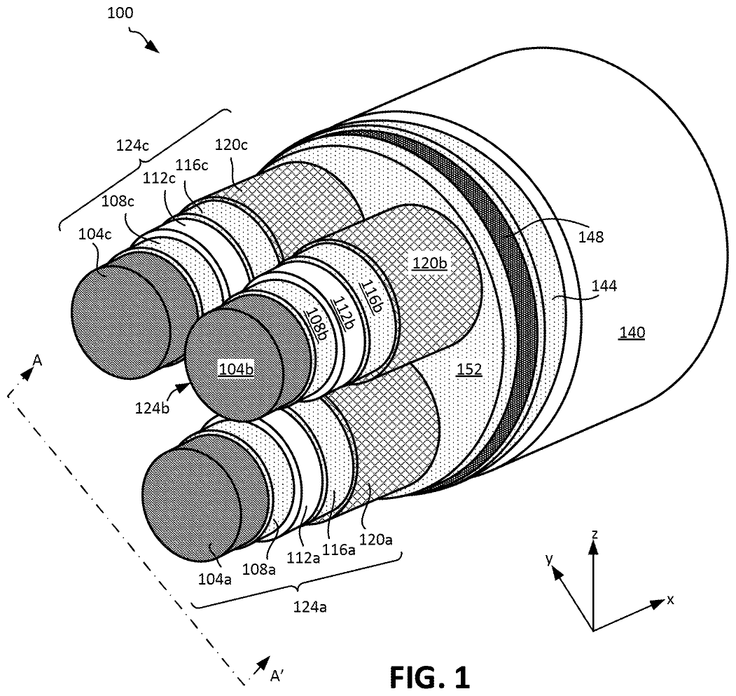

For instance, two phase shields may be electrically coupled to each other, if the two phase shields are in physical contact with each other (e.g., any two of the phase shields 120a, 120b, 120c illustrated in FIGS. 1-4 are in direct physical contact with each other, and hence, electrically coupled).

Also, two phase shields may also be electrically coupled to each other, if the two phase shields are in indirect physical contact with each other, e.g., in physical contact with each other through one or more intervening phase shields. For example, in FIG. 5, the phase shields 120a is in indirect physical contact with the phase shield 120b, through an intervening phase shield 120c. Accordingly, the phase shields 120a is electrically coupled to the phase shield 120b, e.g., through the intervening phase shield 120c.

As described herein, grounding each phase shield and electrically coupling each phase shield results in elimination or at least reduction of the above described power loss due to a fundamental frequency coupling between a corresponding conductor and the corresponding phase shield. For example, electrically coupling the phase shields allows to at least in part cancel out or reduce the current flow through the phase shields, e.g., by cancelling out the above discussed coupling of the high fundamental frequency current. This results in zero or at least decreased power loss in the phase shields of the polyphase cable, thereby improving performance, thermal margin, and/or thickness and weight of the cable.

In one embodiment, the plurality of conductor assemblies may be surrounded by a plurality of additional layers, such as a cable jacket comprising insulating or dielectric fill material, a binding tape comprising insulating or dielectric fill material, an outer shield comprising conductive material (such as braided metal(s) and/or alloys thereof), and/or on outer insulation material layer, in some examples. Thus, in an example, a phase shield of a conductor assembly, along with the outer shield, provides two shielding layers to individual conductors. Such dual or double shielded arrangement results in better management of electromagnetic interface (EMI), such as reduction in EMI, without corresponding significant increase in power loss due to the above described coupling of fundamental frequency currents (e.g., as the phase shields are electrically coupled to each other, such power loss is eliminated or at least reduced).

In accordance with some embodiments of the present disclosure, these various approaches can be used individually or together to reduce high fundamental frequency coupling between individual conductors and corresponding shields in a polyphase cable. Numerous variations and embodiments will be apparent in light of the present disclosure.

As used herein, the term “about” indicates that the value listed may be somewhat altered or otherwise within an acceptable tolerance, as long as the alteration does not result in nonconformance of the process or device. For example, for some elements the term “about” can refer to a variation of ±0.1%, for other elements, the term “about” can refer to a variation of ±1% or ±10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

### Architecture—Resonator and filter structures

FIGS. 1, 2, 3, and 4 illustrate various views of an example polyphase high frequency (such as a frequency of at least 100 Hz, for example) Alternating Current (AC) cable 100 comprising a plurality of conductor assemblies 124a, 124b, 124c corresponding to a plurality of AC phases, wherein each conductor assembly 124 comprises (i) a corresponding conductor 104 and (ii) a corresponding conductive phase shield 120 arranged coaxially around the conductor 104, and wherein the plurality of conductive phase shields 120a, 120b, 120c of the plurality of conductor assemblies 124a, 124b, 124c are grounded as well as electrically coupled to and in physical contact with each other, in accordance with an embodiment of the present disclosure.

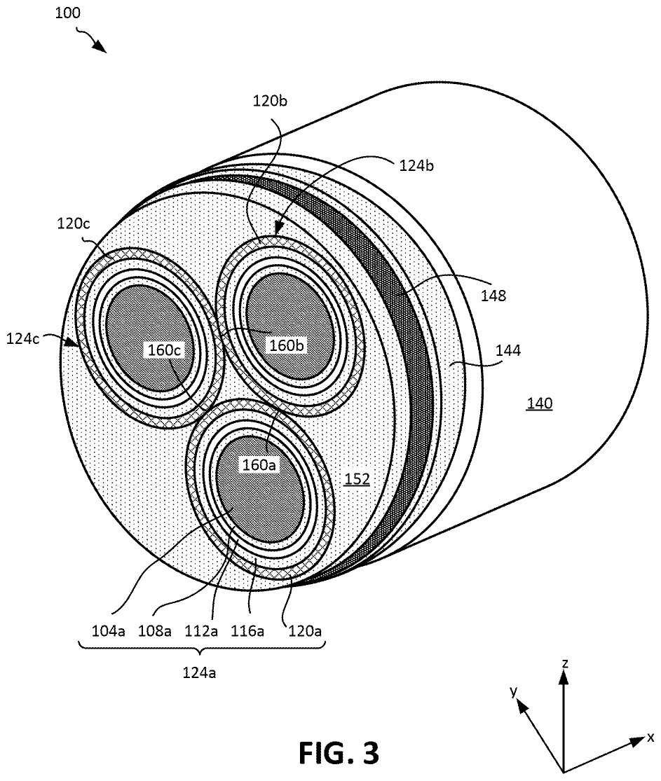

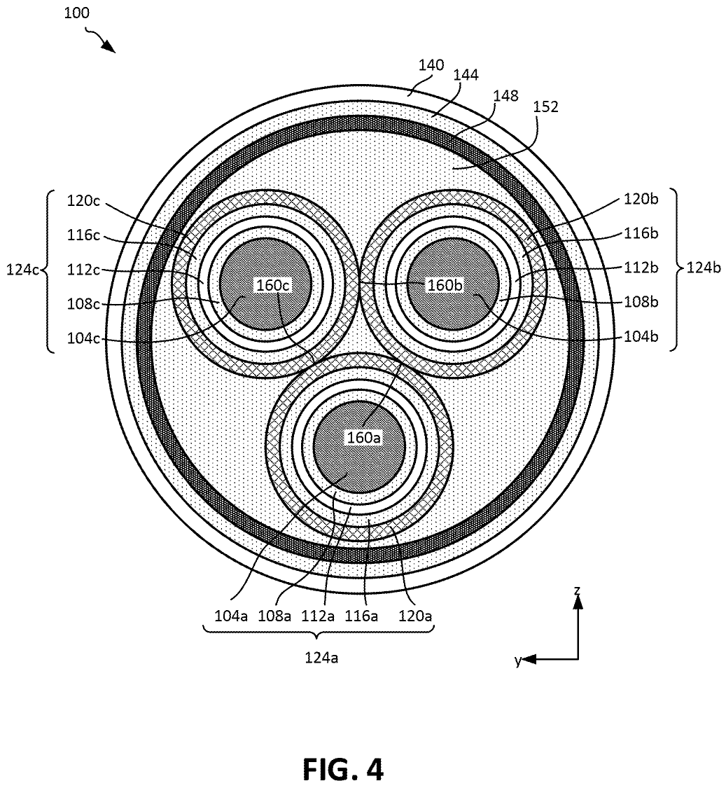

FIG. 1 illustrates a perspective view of the cable 100, and illustrates the three conductor assemblies 124a, 124b, 124c. FIG. 2 illustrates a perspective view of the cable 100, and illustrates the conductor assembly 124a, while illustrating cross-sections of the conductor assemblies 124b, 124c. FIG. 3 illustrates a perspective view of the cable 100, and illustrates cross-sections of the conductor assemblies 124a, 124b, 124c. FIG. 4 illustrates a cross-sectional view of the cable 100, e.g., along line A-A′ of FIG. 1.

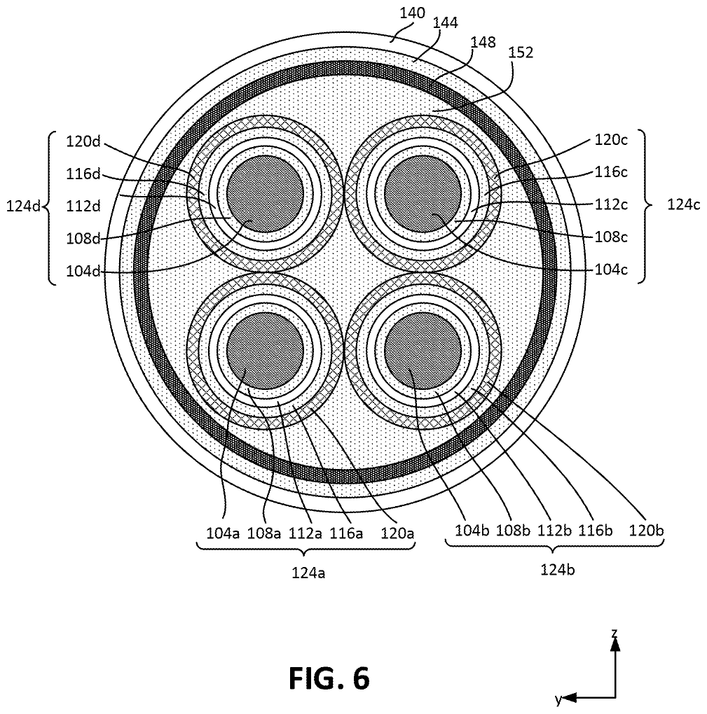

The polyphase cable 100 of FIGS. 1-4 is a three-phase cable, with three conductor assemblies 124a, 124b, 124c. However, the polyphase cable 100 may have any other appropriate number of phases and corresponding number of conductor assemblies as well, such as four phases, five phases, or a higher number of phases (an example four phase cable is described below with respect to FIG. 6). However, irrespective of a number of phases, the phase shields 120 of the plurality of conductor assemblies 124 are in electrical contact with each other, in an example.

In one embodiment, the cable 100 is configured for a high frequency AC operation. For example, a frequency of the current conducted by the cable 100 may range between 100 Hz to 10 kHz. For example, the frequency of the current conducted by the cable 100 may be at least 100 Hz. As described herein below, the conductive phase shields 120a, 120b, 120c being grounded and electrically coupled to each other for such a relatively high frequency operation of the cable 100 facilitates in reduction of electrical power losses.

The cable 100 of FIGS. 1-4 may be configured for any appropriate voltage level. For example, the cable 100 may be configured for a voltage that is within a range of 25 V to 100,000 V. Thus, the cable 100 may be suitable for a wide range of voltages, with a frequency of at least 100 Hz, for example. The cable 100 may be used for any appropriate application, such as driving a polyphase motor or electrical drives, supplying polyphase power, and/or for other appropriate polyphase high frequency (e.g., at least 100 Hz and at most 10 kHz) AC applications. In an example, the cable 100 may be used to drive a polyphase motor or an electrical drive, supply polyphase power, and/or used for another appropriate polyphase high frequency application within an aircraft. For example, the cable may be installed within the aircraft, to be used for an appropriate polyphase high frequency application.

Described herein below is an example conductor assembly 124a of the plurality of conductor assemblies 124a, 124b, 124c, and the description of the conductor assembly 124a, unless otherwise stated, also applies to the other conductor assemblies 124b, 124c.

The conductor assembly 124a comprises the conductor 104a configured to conduct current of a corresponding phase of the three phase AC. The conductor 104a comprises conductive material, such as one or more metals and/or alloys thereof. In an example, the conductor 104a may be solid, or compacted stranded copper or another appropriate metal (such as aluminum, nickel, or another appropriate metal). In an example, the conductor 104a may be coated with another metal, such as tin, silver, nickel, lead, copper plated steel wire, and/or other metal or alloy.

In one embodiment, a semi-conductive material or tape 108a is coaxially arranged around the conductor 104a. In an example, the semi-conductive material 108a may have a resistivity in the range of about 1,000 ohm-m to about 100,000 ohm-m. In an example, the semi-conductive material 108a may have resistivity of at least 1,000 ohm-m, or at least 2,000 ohm-m, or at least 3,000 ohm-m, or at least 5,000 ohm-m. In an example, the semi-conductive material 108a may have resistivity of at most 50,000 ohm-m, or at most 25,000 ohm-m, or at most 10,000 ohm-m, or at most 50,000 ohm-m. In an example, the semi-conductive material 108a may be adhered to the conductor 104a, e.g., eliminate or at least reduce voids or gaps therebetween. In one example, the semi-conductive material 108a comprises carbon black impregnated poly-furfuryl alcohol (PFA), although other examples of the semi-conductive material 108a may also be possible.

In one embodiment, an insulating material or tape 112a is coaxially arranged around the semi-conductive material 108a. In an example, the insulating material 112a (such as a dielectric material having relatively high resistivity) may have a resistivity in mega ohms-m range or in giga ohms-m range. In one example, the insulating material 112a comprises PFA or other appropriate insulating materials such as polyetheretherketone (PEEK), ethylene propylene diene monomer (EPDM), synthetic rubber, and/or another appropriate insulating material used for cabling applications.

In one embodiment, another semi-conductive material or tape 116a is coaxially arranged around the insulating material 112a. In an example, the semi-conductive material 116a may have a resistivity in the range of about 1,000 ohm-m to about 100,000 ohm-m, e.g., similar to, or different from, the semi-conductive material 108a. In one example, the semi-conductive material 112a may be compositionally similar to, or different from, the semi-conductive material 108a.

Thus, in an example, the conductor assembly 124a comprises two layers of semi-conductive material 108a, 116a, and one intervening layer of insulating material 112a. In other examples, the conductor assembly 124a may include a different number of layers of semi-conductive material and/or insulating material. In an example, the one or more layers of semi-conductive material (such as the layers of semi-conductive material 108a and 116a) grades the charge of the conductor 104, so as to eliminate or reduce partial discharge or corona effect in the conductor assembly 124a and cause a slower rate of dissipation of the voltage of the conductor 104a. In an example, the thickness and/or a number of layers of the semi-conductive material and/or the layer of insulating material used in the cabling assembly 124a may be based at least in part on a voltage rating of the cable 100, and may be implementation specific.

In one embodiment, the phase shield 120a of the conductor assembly 124a is coaxially arranged around the semi-conductive material 116a. The phase shield 120a comprises conductive material, such as one or more metals and/or alloys thereof. Any appropriate metal may be used, such as copper, aluminum, and/or nickel. In an example, the phase shield 120a comprises metallic braid or tape wrap.

Thus, the conductor assembly 124a comprises the coaxially arranged conductor 104a, the semi-conductive material 108a, the insulating material 112a, the semi-conductive material 116a, and the phase shield 120a. Similarly, the conductor assembly 124b comprises a coaxially arranged conductor 104b, a semi-conductive material 108b, an insulating material 112b, a semi-conductive material 116b, and a phase shield 120b, each of which are similar to the respective components of the conductor assembly 124a. Similarly, the conductor assembly 124c comprises a coaxially arranged conductor 104c, a semi-conductive material 108c, an insulating material 112c, a semi-conductive material 116c, and a phase shield 120c, each of which are similar to the respective components of the conductor assembly 124a.

In one embodiment, the conductive phase shields 120a, 120b, 120c of the conductor assemblies 124a, 124b, 124c are grounded and electrically coupled to each other. For example, for the three phase cable 100 of FIG. 1-4, each phase shield is physically in contact with the two other phase shields. For example, referring to FIGS. 2-4, the phase shield 120a is in physical contact with the phase shield 120b at a region of contact 160a, the phase shield 120b is in physical contact with the phase shield 120c at a region of contact 160b, and the phase shield 120c is in physical contact with the phase shield 120a at a region of contact 160c. Thus, the phase shields 120a, 120b, 120c are all in physical contact with each other, and hence, in electrical contact with each other.

In FIGS. 1-4, the phase shields 120a, 120b, 120c are all in physical contact with each other. However, in another example, each of the phase shields 120a, 120b, 120c may not be in direct physical contact with the other two of the phase shields 120a, 120b, 120c, e.g., as long as the phase shields 120a, 120b, 120c are in electrical contact with each other. For example, FIG. 5 illustrates another example polyphase high frequency AC cable 500 that is at least in part similar to the polyphase high frequency AC cable 100 of FIGS. 1-4, and wherein the plurality of conductive phase shields 120a, 120b, 120c of the plurality of conductor assemblies 124a, 124b, 124c are grounded and electrically coupled to (but not necessarily directly physically coupled to) each other, in accordance with an embodiment of the present disclosure.

In more detail, in the example of FIG. 5, the phase shield 120a of the conductor assembly 124a is in physical contact with the phase shield 120c of the conductor assembly 124c, e.g., along the region of contact 160c; however, the phase shield 120a of the conductor assembly 124a is not in direct physical contact with the phase shield 120b of the conductor assembly 124b. The phase shield 120c of the conductor assembly 124c is in physical contact with the phase shield 120b of the conductor assembly 124c, e.g., along the region of contact 160b. Thus, the phase shield 120a of the conductor assembly 124a is in indirect physical contact with the phase shield 120b of the conductor assembly 124c, e.g., through the phase shield 120c, and hence, the phase shield 120a is in electrical contact with the phase shield 120b, through the phase shield 120c. Thus, similar to the conductor assembly 100 of FIG. 1-4, in FIG. 5 the phase shields 120a, 120b, 120c of the cable 500 are each in electrical contact with each other, but not all are in physical contact with each other.

Referring again to FIG. 1-4, each of the phase shields 120a, 120b, 120c is grounded at one or both ends of the cable 100. For example, if the cable 100 extends from a first point to a second point, the phase shields 120a, 120b, 120c are grounded at the first point and/or the second point.

In an example, a single turn transformer may develop for each conductor assembly 124a, 124b, 124c, which may allow to couple the fundamental frequency of operation between each conductor 104 and corresponding phase shield 120. For example, a single turn transformer may couple the fundamental frequency between the conductor 104a and the phase shield 120a, another a single turn transformer may couple the fundamental frequency between the conductor 104b and the phase shield 120b, and yet another single turn transformer may couple the fundamental frequency between the conductor 104c and the phase shield 120c. If the phase shields 120a, 120b, 120c are not in electrical contact with each other, such couplings of the fundamental frequency results in current conduction though the phase shields 120a, 120b, 120c. For example, if a three phase motor is being driven at 500 Hz AC and 100 amperes and the phase shields 120a, 120b, 120c are not electrically coupled to each other, this may result in a current conduction of about 15 to 45 amperes (such as about 30 amperes) within each of the phase shields 120a, 120b, 120c (an exact amount of current may be implementation specific, and may depend on various criteria such as thickness and nature of the semi-conductive and insulating materials 108, 112, 116). Thus, this results in power loss in the cable 100. Such power loss may be especially relevant for relatively high frequency operation of the cable, such as for a frequency greater than 100 Hz, or 200 Hz, or 300 Hz, or 400 Hz, or 500 Hz, for example. In an example, such power loss may contribute to relatively smaller thermal margins and/or relatively heavier cables.

However, electrically coupling the phase shields 120a, 120b, 120c allows to at least in part cancel out or reduce the current flow through the phase shields 120a, 120b, 120c, e.g., by cancelling out the above discussed coupling of the high fundamental frequency current. For example, effects of the above described single turn transformer is eliminated or at least reduced, e.g., due to the electrical coupling of the phase shields 120a, 120b, 120c. Merely as an example, if a three phase motor is being driven at 500 Hz AC and 100 amperes and the phase shields 120a, 120b, 120c are electrically coupled to each other, this may result in a reduced current conduction of about 2 to 5 amperes within each of the phase shields 120a, 120b, 120c (again, an exact amount of current may be implementation specific, and may depend on various criteria such as thickness and nature of the semi-conductive and insulating materials 108, 112, 116). Thus, electrically coupling the phase shields 120a, 120b, 120c to each other results in elimination, or at least reduction of high frequency fundamental coupling between the phase shields 120a, 120b, 120c and the conductors 104a, 104b, 104c, respectively.

In an example, a phase shield 120 of a conductor assembly 124 provides a shielding layer. Note that another shielding layer may be formed by an outer shield 144 described below. Thus, two shielding layers are provided for each phase in the cable 100, e.g., shielding layers 120a and 144 for the conductor 104a, shielding layers 120b and 144 for the conductor 104b, and shielding layers 120c and 144 for the conductor 104c. Thus, such dual or double shielded arrangement results in better management of electromagnetic interface (EMI), such as reduction in EMI, without corresponding significant increase in power loss due to the above described coupling of fundamental frequency currents (e.g., as the phase shields are electrically coupled to each other, such power loss is eliminated or at least reduced).

Referring again to FIGS. 1-4 and continuing with the description of the cable 100, in an example, a cable jacket 152 is coaxially arranged around the plurality of conductor assemblies 124a, 124b, 124c. The cable jacket 152 comprises a dielectric or insulating fill material, such as a fluoropolymer (e.g., polytetrafluoroethylene or PTFE), although other types of material may also be used, such as EPDM, nitrile, hydrogenated acrylonitrile butadiene rubber (HNBR), and/or chloroprene, for example.

In one embodiment, a binding material 148, such as a binding tape, is arranged coaxially around the cable jacket 152. The binding material 148 may be an appropriate material to bind the conductor assemblies 124a, 124b, 124c and the cable jacket 152, such as an electrical tape, a polyimide film tape with silicone adhesive, or another material appropriate as binding material of a cable. The binding material 148 may comprise a semi-conductive material or an insulating material, in an example.

In one embodiment, an outer shield 144 is arranged coaxially around the binding material 148. The outer shield 144 comprises conductive material, such as one or more metals and/or alloys thereof. Any appropriate metal may be used, such as copper, aluminum, and/or nickel. In an example, the outer shield 144 is braided. In an example, the outer shield 144 is grounded at one or both ends of the cable 100. For example, if the cable 100 extends from a first point to a second point, the outer shield 144 is grounded at the first point and/or the second point.

In an example, the phase shields 120a, 120b, 120c, and the outer shield 144 eliminates or reduces EMI for the conductors 120a, 120b, 120c of the cable 100. Thus, each conductor 104 has two layers of metallic shield, such as a corresponding phase shield 120 and the outer shield 144, where the phase shields 120 and possibly the outer shield 144 are grounded, in an example. Thus, the cable 100 is a double shielded cable.

However, in some other examples, the cable 100 may instead be a single shielded cable. In some such examples, the outer shield 144 may be absent, and the electrically coupled and grounded phase shields 12a, 120b, 120c may provide a single layer of shield to corresponding conductors 104a, 104b, 104c, respectively.

In one embodiment, an outer insulation armor 140 is arranged coaxially around the outer shield 144. The outer insulation armor 140 comprises an appropriate insulation material, such as PFA.

FIGS. 1-5 illustrate a three phase cable 100. However, in some examples and as described above, the cable 100 may have more than three phases, such as four, five, or another appropriate higher number of phases. For example, FIG. 6 illustrates cross-sectional view of an example four-phase high frequency AC cable 600 comprising four conductor assemblies 124a, 124b, 124c, 124d corresponding to the four phases, wherein each conductor assembly 124 comprises (i) a corresponding conductor 104 and (ii) a corresponding conductive phase shield 120 arranged coaxially around the conductor 104, and wherein the four conductive phase shields 120a, 120b, 120c, 120d of the four conductor assemblies 124a, 124b, 124c, 124d are grounded and electrically coupled to and each other, in accordance with an embodiment of the present disclosure. Similar components in the cables 600 and 100 are similarly labelled. Description of the cable 100 of FIGS. 1-4, unless contradictory in nature, also applies for the cable 600 of FIG. 6.

In the example of FIG. 6 where there are four phases, the phase shield 120a of the conductor assembly 124a is in physical contact with the phase shield 120b of the conductor assembly 124b, the phase shield 120b of the conductor assembly 124b is also in physical contact with the phase shield 120c of the conductor assembly 124c, the phase shield 120c of the conductor assembly 124c is also in physical contact with the phase shield 120d of the conductor assembly 124d, and the phase shield 120d of the conductor assembly 124d is also in physical contact with the phase shield 120a of the conductor assembly 124a, as illustrated in FIG. 6.

Thus, each of the four phase shields 120a, 120b, 120c, and 120d is in physical contact with two other phase shields. Accordingly, the four phase shields 120a, 120b, 120c, and 120d are in electrical contact with each other. Also, in an example, each of the four phase shields 120a, 120b, 120c, and 120d is grounded on one or both ends of the cable 600. Thus, as described above for the cable 100, the electrical coupling of the four phase shields 120a, 120b, 120c, and 120d in the cable 600 also results in eliminate or at least reduction of power loss due to the fundamental frequency coupling between the conductors 104a, . . . , 104d and the corresponding phase shields 120a, . . . , 120d, respectively.

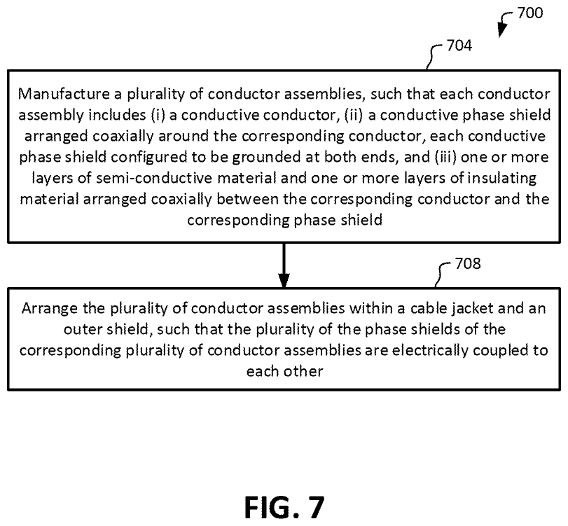

FIG. 7 illustrate a flowchart depicting a method 700 for manufacturing a polyphase cable, such as any of the cables of FIGS. 1-6, wherein the cable comprises a plurality of conductor assemblies, wherein each conductor assembly comprises (i) a corresponding conductor and (ii) a corresponding conductive phase shield arranged coaxially around the conductor, and wherein the plurality of conductive phase shields of the plurality of conductor assemblies are grounded and electrically coupled to with each other, in accordance with an embodiment of the present disclosure.

At 704 of the method 700, a plurality of conductor assemblies 124a, 124b, 124c of the cable 100 (and may be additionally the conductor assembly 124d of the cable 500) are manufactured, e.g., using appropriate techniques to manufacture conductor assemblies. For example, each conductor assembly 124 includes (i) a conductive conductor 104, (ii) a conductive phase shield 120 arranged coaxially around the corresponding conductor 104, and (iii) one or more layers of semi-conductive material and one or more layers of insulating material (such as layers 108, 112, and/or 116 for each conductor assembly) arranged coaxially between the corresponding conductor 104 and the corresponding phase shield 120. In an example, each conductive phase shield 120 is configured to be grounded any one or both ends of the cable.

The method 700 then proceeds from 704 to 708. At 708, the plurality of conductor assemblies is arranged within a cable jacket and an outer shield (such as the cable jacket 152 and the outer shield 144), such that the plurality of the phase shields of the corresponding plurality of conductor assemblies are electrically coupled to each other, e.g., as described above with respect to FIGS. 1-6. For example, FIGS. 2-3 illustrate the phase shields 120a, 120b, 120c in physical contact and electrical contact with each other, as an example.

Note that the processes in method 700 are shown in a particular order for ease of description. However, one or more of the processes may be performed in a different order or may not be performed at all (and thus be optional), in accordance with some embodiments. Numerous variations on method 700 and the techniques described herein will be apparent in light of this disclosure.

### Further Example Embodiments

The following examples pertain to further embodiments, from which numerous permutations and configurations will be apparent.

Example 1. A polyphase cable comprising: a first conductor, a first shield comprising conductive material coaxially around the first conductor, and a first insulating material between and separating the first conductor and the first shield; and a second conductor, a second shield comprising conductive material coaxially around the second conductor, and a second insulating material between and separating the second conductor and the second shield; wherein the first shield is in physical contact with the second shield.

Example 2. The polyphase cable of example 1, wherein the polyphase cable is rated to conduct polyphase Alternating Current (AC) having a frequency between 100 Hertz (Hz) and 10,000 Hertz (Hz).

Example 3. The polyphase cable of any one of examples 1-2, wherein in operation, one or both of a first end and a second end of one or both of the first shield and the second shield are grounded.

Example 4. The polyphase cable of any one of examples 1-3, further comprising: a third conductor, a third shield comprising conductive material coaxially around the third conductor, and a third insulating material between and separating the third conductor and the third shield; wherein the third shield is in physical contact with one of the first and second shields, and not in physical contact with the other of the first and second shields.

Example 5. The polyphase cable of any one of examples 1-3, further comprising: a third conductor, a third shield comprising conductive material coaxially around the third conductor, and a third insulating material between and separating the third conductor and the third shield; wherein the third shield is in physical contact with both the first and second shields.

Example 6. The polyphase cable of any one of examples 4-5, wherein the polyphase cable is a 3-phase Alternating Current (AC) cable, where the first, second, and third conductors are configured to respectively transmit three phases of the 3-phase AC.

Example 7. The polyphase cable of any one of examples 4-6, further comprising: a fourth conductor, a fourth shield comprising conductive material coaxially around the fourth conductor, and a fourth insulating material between and separating the fourth conductor and the fourth shield; wherein the fourth shield is in physical contact with only two of the first, second, and third shields.

Example 8. The polyphase cable of any one of examples 1-7, further comprising: a first layer of semi-conductive material coaxially around the first conductor, and between the first conductor and the first insulating material; and a second layer of semi-conductive material coaxially around the first conductor, and between the first insulating material and the first shield.

Example 9. The polyphase cable of any one of examples 1-8, further comprising: an outer shield comprising conductive material, the outer shield coaxially around the first shield and the second shield.

Example 10. The polyphase cable of example 9, wherein one or both of a first end and a second end of the outer shield are configured to be grounded.

Example 11. The polyphase cable of any one of examples 9-10, further comprising: an insulating fill material, such that the first shield and the second shield extend through the insulating fill material, wherein the outer shield is coaxially around the insulating fill material.

Example 12. The polyphase cable of any one of examples 1-11, wherein the first shield and the second shield comprise a metal.

Example 13. The polyphase cable of any one of examples 1-12, wherein the first shield and the second shield comprise at least one of copper, aluminum, or nickel.

Example 14. The polyphase cable of any one of examples 1-13, wherein one or both the first shield and the second shield are braided.

Example 15. An aircraft comprising the polyphase cable of any one of examples 1-14 installed therein.

Example 16. A method of forming a polyphase cable, the method comprising: manufacturing a plurality of conductor assemblies, such that each conductor assembly includes (i) a conductive conductor, (ii) a conductive phase shield arranged coaxially around the corresponding conductor, and (iii) one or more layers of semi-conductive material and one or more layers of insulating material arranged coaxially between the corresponding conductor and the corresponding phase shield; and arranging the plurality of conductor assemblies within a cable jacket, such that the phase shields are electrically coupled to each other.

Example 17. The method of example 16, wherein, each of the phase shields is in physical contact with at least one other of the phase shields, the method further comprising: grounding one or both ends of each phase shield.

Example 18. A polyphase cable comprising: a plurality of conductor assemblies, each conductor assembly including (i) a conductive conductor, (ii) a conductive phase shield arranged coaxially around the corresponding conductor, and (iii) one or more layers of semi-conductive material and one or more layers of insulating material arranged coaxially between the corresponding conductor and the corresponding phase shield, wherein the phase shields are electrically coupled to each other; and a cable jacket coaxially around the plurality of conductor assemblies.

Example 19. The polyphase cable of example 18, wherein the polyphase cable is configured to conduct polyphase Alternating Current (AC) having a frequency of at least 100 Hertz (Hz).

Example 20. The polyphase cable of any one of examples 18-19, wherein each of the phase shields is in physical contact with at least one other of the phase shields, and one or both ends of each phase shield of the plurality of phase shields are configured to be grounded.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A polyphase cable comprising:
a first conductor, a first shield comprising conductive material coaxially around the first conductor, and a first insulating material between and separating the first conductor and the first shield; and
a second conductor, a second shield comprising conductive material coaxially around the second conductor, and a second insulating material between and separating the second conductor and the second shield;
wherein the first shield is in physical contact with the second shield.

2. The polyphase cable of claim 1, wherein the polyphase cable is rated to conduct polyphase Alternating Current (AC) having a frequency between 100 Hertz (Hz) and 10,000 Hertz (Hz).

3. The polyphase cable of claim 1, wherein in operation, one or both of a first end and a second end of one or both of the first shield and the second shield are grounded.

4. The polyphase cable of claim 1, further comprising:
a third conductor, a third shield comprising conductive material coaxially around the third conductor, and a third insulating material between and separating the third conductor and the third shield;
wherein the third shield is in physical contact with one of the first and second shields, and not in physical contact with the other of the first and second shields.

5. The polyphase cable of claim 1, further comprising:
a third conductor, a third shield comprising conductive material coaxially around the third conductor, and a third insulating material between and separating the third conductor and the third shield;
wherein the third shield is in physical contact with both the first and second shields.

6. The polyphase cable of claim 5, wherein the polyphase cable is a 3-phase Alternating Current (AC) cable, where the first, second, and third conductors are configured to respectively transmit three phases of the 3-phase AC.

7. The polyphase cable of claim 5, further comprising:
a fourth conductor, a fourth shield comprising conductive material coaxially around the fourth conductor, and a fourth insulating material between and separating the fourth conductor and the fourth shield;
wherein the fourth shield is in physical contact with only two of the first, second, and third shields.

8. The polyphase cable of claim 1, further comprising:
a first layer of semi-conductive material coaxially around the first conductor, and between the first conductor and the first insulating material; and
a second layer of semi-conductive material coaxially around the first conductor, and between the first insulating material and the first shield.

9. The polyphase cable of claim 1, further comprising:
an outer shield comprising conductive material, the outer shield coaxially around the first shield and the second shield.

10. The polyphase cable of claim 9, wherein one or both of a first end and a second end of the outer shield are configured to be grounded.

11. The polyphase cable of claim 9, further comprising:
an insulating fill material, such that the first shield and the second shield extend through the insulating fill material, wherein the outer shield is coaxially around the insulating fill material.

12. The polyphase cable of claim 1, wherein the first shield and the second shield comprise a metal.

13. The polyphase cable of claim 1, wherein the first shield and the second shield comprise at least one of copper, aluminum, or nickel.

14. The polyphase cable of claim 1, wherein one or both the first shield and the second shield are braided.

15. An aircraft comprising the polyphase cable of claim 1 installed therein.

16. A method of forming a polyphase cable, the method comprising:
manufacturing a plurality of conductor assemblies, such that each conductor assembly includes (i) a conductive conductor, (ii) a conductive phase shield arranged coaxially around the corresponding conductor, and (iii) one or more layers of semi-conductive material and one or more layers of insulating material arranged coaxially between the corresponding conductor and the corresponding phase shield; and
arranging the plurality of conductor assemblies within a cable jacket, such that the phase shields are electrically coupled to each other.

17. The method of claim 16, wherein, each of the phase shields is in physical contact with at least one other of the phase shields, the method further comprising:
grounding one or both ends of each phase shield.

18. A polyphase cable comprising:
a plurality of conductor assemblies, each conductor assembly including (i) a conductive conductor, (ii) a conductive phase shield arranged coaxially around the corresponding conductor, and (iii) one or more layers of semi-conductive material and one or more layers of insulating material arranged coaxially between the corresponding conductor and the corresponding phase shield, wherein the phase shields are electrically coupled to each other; and
a cable jacket coaxially around the plurality of conductor assemblies.

19. The polyphase cable of claim 18, wherein the polyphase cable is configured to conduct polyphase Alternating Current (AC) having a frequency of at least 100 Hertz (Hz).

20. The polyphase cable of claim 18, wherein each of the phase shields is in physical contact with at least one other of the phase shields, and one or both ends of each phase shield of the plurality of phase shields are configured to be grounded.
